(19) United States
(12) Patent Application Publication
(10) Pub. No.: US 2026/0371189 A1
(43) Pub. Date: Nov. 19, 2026

(54) UPLINK TRANSMISSION TIMING MANAGEMENT IN MULTI-TRP OPERATION

(71) Applicant: APPLE INC., Cupertino, CA (US)

(72) Inventors: Qiming Li, Beijing (CN); Hong He, San Jose, CA (US); Yang Tang, San Jose, CA (US); Jie Cui, San Jose, CA (US); Manasa Raghavan, Sunnyvale, CA (US); Naveen Kumar R Palle Venkata, San Diego, CA (US); Dawei Zhang, Saratoga, CA (US)

(21) Appl. No.: 19/147,882

(22) PCT Filed: Feb. 16, 2023
(86) PCT No.: PCT/CN2023/076445

§ 371 Date: Jul. 14, 2025

(51) Int. Cl. H04W 36/00; H04W 76/15

(52) U.S. Cl. CPC H04W 36/0077; H04W 76/15

(57) ABSTRACT

There is provided an apparatus of a user equipment (UE), the apparatus comprising a processor, and a memory storing instructions that, when executed by the processor, configure the apparatus to: monitor a transmission timing difference (TTD) or a reception timing difference (RTD) between multiple Transmit Receive Points (TRPs); determine a first event that the TTD or the RTD is not beyond a respective threshold related to the UE's capability, or a second event that the TTD or the RTD is beyond the respective threshold; and enable two or more Timing Advance Groups (TAGs) for the multiple TRPs in the first event, or a single TAG for the multiple TRPs in the second event.

### TECHNICAL FIELD

The present application relates generally to wireless communication systems, including providing uplink transmission timing management in multi-Transmit Receive Point (TRP) operation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

The ever increasing number of features and functionality introduced in wireless communication devices also creates a continuous need for improvement in both wireless communications and in wireless communication devices. To increase coverage and better serve the increasing demand and range of envisioned uses of wireless communication, there are further wireless communication technologies under development, including the 5G NR.

### SUMMARY

In one aspect, there is provided an apparatus of a user equipment (UE), the apparatus comprising: a processor; and a memory storing instructions that, when executed by the processor, configure the apparatus to: monitor a transmission timing difference (TTD) or a reception timing difference (RTD) between multiple Transmit Receive Points (TRPs); determine a first event that the TTD or the RTD is not beyond a respective threshold related to the UE's capability, or a second event that the TTD or the RTD is beyond the respective threshold; and enable two or more Timing Advance Groups (TAGs) for the multiple TRPs in the first event, or a single TAG for the multiple TRPs in the second event.

In another aspect, there is provided an apparatus of a base station, the apparatus comprising: a processor; and a memory storing instructions that, when executed by the processor, configure the apparatus to: receive, from a UE, a report for a first event that a transmission timing difference (TTD) or a reception timing difference (RTD) between multiple Transmit Receive Points (TRPs) is not beyond a respective threshold related to the UE's capability, or for a second event that the TTD or the RTD is beyond the respective threshold; and send, to the UE, two or more Timing Advance (TA) values for two or more Timing Advance Group (TAGs) enabled for the multiple TRPs in the first event, or one TA value for a single TAG enabled in the second event.

In still another aspect, there is provided a method, comprising: monitoring a transmission timing difference (TTD) or a reception timing difference (RTD) between multiple Transmit Receive Points (TRPs); determining a first event that the TTD or the RTD is not beyond a respective threshold related to the UE's capability, or a second event that the TTD or the RTD is beyond the respective threshold; and enabling two or more Timing Advance Groups (TAGs) for the multiple TRPs in the first event, or a single TAG for the multiple TRPs in the second event.

In yet still another aspect, there is provided a method, comprising: receiving, from a UE, a report for a first event that a transmission timing difference (TTD) or a reception timing difference (RTD) between multiple Transmit Receive Points (TRPs) is not beyond a respective threshold related to the UE's capability, or for a second event that the TTD or the RTD is beyond the respective threshold; and sending, to the UE, two or more Timing Advance (TA) values for two or more Timing Advance Group (TAGs) enabled for the multiple TRPs in the first event, or one TA value for a single TAG enabled in the second event.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to some aspects of the present application.

FIG. 2 illustrates a system for performing signaling between a wireless device and a network device, according to some aspects of the present application.

FIG. 3 illustrates an example scenario of multi-TRP transmissions according to some aspects of the present application.

FIG. 4 is a diagram illustrating a frame structure in 5G NR.

FIG. 5 is a diagram illustrating a timing relation between uplink and downlink.

FIG. 6 illustrates an example of RTD/TTD thresholds according to some aspects of the present application.

FIGS. 7A and 7B illustrate examples of TAG configuration for multi-TRP operation according to some aspects of the present application.

FIGS. 8A and 8B illustrate examples of multi-TRP in different events according to some aspects of the present application.

FIG. 9 is a flowchart diagram illustrating an example method for supporting the multi-TRP operation according to some aspects of the present application.

FIG. 10 is a flowchart diagram illustrating an example method for supporting the multi-TRP operation according to some aspects of the present application.

### DETAILED DESCRIPTION

Various illustrative embodiments of the present application will be described hereinafter with reference to the drawings. For purpose of clarity and simplicity, not all features are described in the specification. Note that, however, many settings specific to the implementations can be made in practicing the embodiments of the present disclosure. In addition, it should be noted that in order to avoid obscuring the description, some of the figures illustrate only steps of a process and/or components of a device that are closely related to the technical solutions of the present application, while in some other figures, well-known process steps and/or device structures are shown for only better understanding of the present application.

For convenient explanation, various aspects of the present application will be described below in the context of the 5G NR. However, it should be noted that this is not a limitation on the scope of application of the present application, and one or more aspects of the present application can also be applied to wireless communication systems that have been commonly used, such as the 4G LTE/LTE-A, or various wireless communication systems to be developed in future. Equivalents to the architecture, entities, functions, processes and the like as described in the following description may be found in these communication systems.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

Moreover, various embodiments are described with regard to a “base station”. However, reference to a base station is merely provided for illustrative purposes. The term “base station” as used in the present application is an example of a control device in a wireless communication system, with its full breadth of ordinary meaning. For example, in addition to the gNB specified in the 5G NR, the “base station” may also be, for example, an eNB in the LTE communication system, a remote radio head, a wireless access point, a relay node, a drone control tower, or any communication device or an element thereof for performing a similar control function.

### System Overview

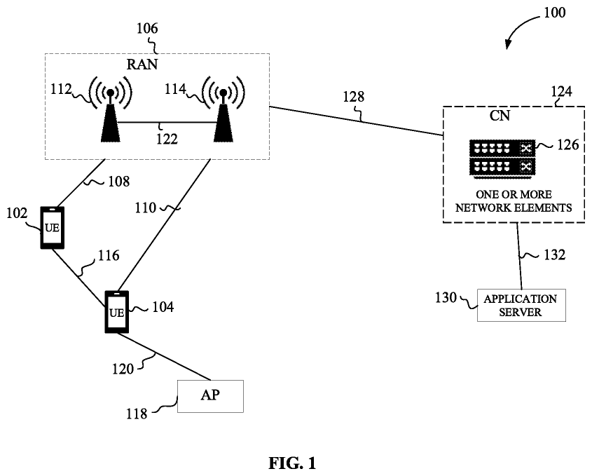

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

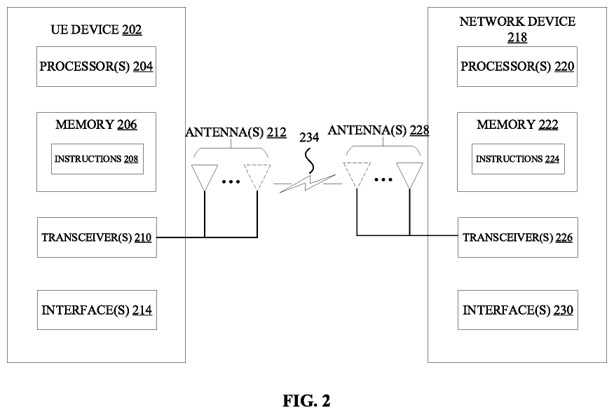

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### Multi-TRP Operation

New cellular communication techniques are continually under development, to increase coverage, to better serve the range of demands and use cases, and for a variety of other reasons. One technique that is currently under development may include supporting multi-TRP operation, for example, for purpose of higher throughput or reliability.

In a wireless communication system, such as the wireless communication system 100, a number of access nodes are deployed. The access node includes an access node controller (ANC), which may be a central unit (CU) of a distributed RAN, such as the RAN 106. The backhaul interface to a core network, such as the CN 124, may terminate at the ANC. The backhaul interface to neighboring access nodes may terminate at the ANC. The ANC may include one or more TRPs. The TRP (which is completely referred to as Transmit Receive Point) may correspond to an eNB, a gNB, an APs, or some other term. In some cases, “TRP” may be used interchangeably with “cell”.

FIG. 3 illustrates an example scenario of the multi-TRP transmission according to some aspects of the present application, in which two TRPs are shown for purpose of explanation, but the number of TRPs is not limited particularly. As shown in FIG. 3, the UE is scheduled to perform downlink (DL) and/or uplink (UL) transmissions with the TRPs, namely, TRP 1 and TRP 2.

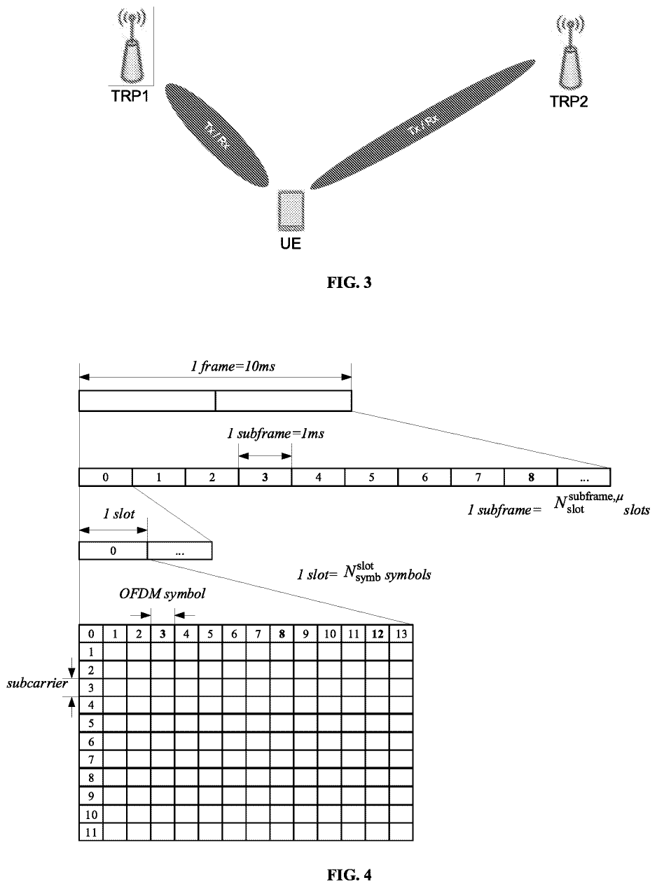

In the 5G NR, both of downlink and uplink transmissions are organized into frames. FIG. 4 shows a diagram of a frame structure in 5G NR. As a fixed frame compatible with LTE/LTE-A, the frame in NR also has a length of 10 ms and includes 10 subframes of equal size, each of which has a length of 1 ms. Unlike LTE/LTE-A, the frame structure in NR has a flexible structure that depends on supported Sub-Carrier Spacing (SCS). Each subframe has a configurable number

$${N}_{slot}^{subframe , μ}$$

(e.g., 1, 2, 4, 8 or 16) of time slots. Each slot also has a configurable number

$${N}_{symb}^{slot}$$

of OFDM symbols. For a normal cyclic prefix, each slot includes 14 consecutive OFDM symbols, and for an extended cyclic prefix, each slot includes 12 consecutive OFDM symbols. In the frequency domain dimension, each time slot includes several resource blocks, and each resource block includes 12 consecutive subcarriers in the frequency domain, for example. Thus, a resource grid can be used to represent resource elements (RE) in a time slot, as shown in FIG. 4.

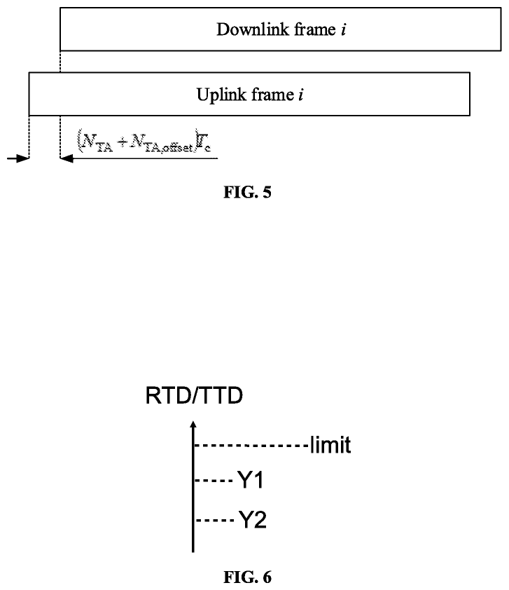

There is a set of frames in the uplink and a set of frames in the downlink on a carrier. In some communications systems, a UE and a TRP may maintain synchronization between the uplink frames and the downlink frames using a set of Timing Advances (TAs). FIG. 5 illustrates uplink-downlink timing relation. A shown, uplink frame number i for transmission from the UE shall start T_{TA}=(N_{TA}+N_{TA,offset})T_{c} before the start of the corresponding downlink frame at the UE, where N_{TA,offset} is a timing advance offset for a serving cell and depends on the frequency band. If the UE is configured with two UL carriers for a serving cell, a same timing advance offset value N_{TA,offset} applies to both carriers. The value of N_{TA} can be adjusted by a Timing Advance Command (TAC) for a Timing Advance Group (TAG). A TAG refers to a group of serving cells that is configured by Radio Resource Control (RRC) and that, for the cells with a UL configured, uses the same timing reference cell and the same TA value.

For example, the UE may apply a TA to a timing of an uplink transmission to account for a round trip time (RTT) delay. By applying the TA, the UE ensures that the uplink transmission is transmitted at a correct time with regard to allocated resources, TRP reception, and/or the like, thereby maintaining synchronization in a network. A base station (e.g., which may correspond to one or more of the TRPs, as described above) may determine a TA and may provide the TA to the UE. For example, the base station may receive a physical random access channel (PRACH) transmission from the UE and determine an estimate of the RTT, from which the base station may determine a TA that the UE is to apply on subsequent transmissions. The base station may provide an indication of the TA to the UE as a TAC of random access response, and the TAC, T_{A}, for a TAG indicates N_{TA} values by index values of T_{A}=0, 1, 2, . . . , 3846, where an amount of the time alignment for the TAG with SCS of 2^{μ}□5 kHz is N_{TA}=T_{A}□6□64/2^{μ}, which is relative to the SCS of the first uplink transmission from the UE after the reception of the random access response. In other cases, a TA may be determined and provided to the UE, as a TAC in Medium Access Control (MAC) control element (CE), and the TAC, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}□5 kHz, N_{TA_new}=N_{TA_old}+(T_{A}−31)□6□64/2^{μ}.

In legacy multi-TRP scenario, only one TA is supported. In other words, uplink transmissions of a UE toward multiple TRPs shall be configured within the same TAG which shares the same TA. However, this may raise some problems. For example, in the exemplary scenario of FIG. 3, the UE may have different distances from TRP 1 and TRP 2, which causes a difference in misalignments of the downlink and uplink frames for TRP 1 and TRP 2. If the UE performs uplink transmissions to both of TRP 1 and TRP 2 with the same TA, a reception quality of at least one transmission may be deteriorated.

According to some aspects of the present application, there is provided a mechanism that supports more than one TA in the multi-TRP uplink transmissions.

To some extent, capability of a UE to support multiple TAs (two or more TAs) for the multi-TRP uplink transmission depends on a limit of transmission timing difference (TTD) that can be handled by the UE. The TTD may be defined as a difference between a subframe timing boundary of an uplink frame from a TRP and that of an uplink frame from another TRP. Similarly, a reception timing difference (RTD) for a UE may be defined as a difference between a subframe timing boundary of a downlink frame from a TRP and that of a downlink frame from another TRP.

Different UEs may have different capabilities of handling downlink receptions within the limit of RTD, which is also referred to as a maximum RTD (MRTD), and of handling uplink transmissions within the limit of TTD, which is also referred to a maximum TTD (MTTD).

For example, in a frequency range FR1 (so-called sub 6 GHz), for both intra-cell and inter-cell multi-TRP, the MRTD between multiple TRPs can be assumed within a cyclic prefix (CP) length as baseline and the MTTD can be CP+M1 μs for FR1, where M1 is to be determined. For a UE capable of supporting RTD>CP (as an optional UE capability), the MRTD/MTTD value is 33/34.6 μs.

In a frequency range FR2 (so-called millimeter wave), for both intra-cell and inter-cell multi-TRP, the MRTD between multiple TRPs can be assumed within a CP length as baseline, and the MTTD can be CP+M2 μs for FR2, where M2 is to be determined. For a UE capable of supporting RTD>CP (as an optional UE capability), the MRTD/MTTD value is 8/8.5 μs.

For a UE, multiple TAs can be supported only if an actual TTD is no larger than the MTTD that the UE can supported. The actual TTD is generally influenced by a propagation delay difference between the UE and multiple TRPs. Due to movement or rotation of the UE, the actual TTD would change from time to time. Note that the actual TTD can be observed only on the UE side. If the TTD exceeds the limit that can be supported, the UE may fail in the multi-TRP uplink transmissions with separate TAs.

According to an embodiment of the present application, the UE may report its MTTD and/or MRTD information to the base station. As an option, the UE may report the MTTD/MRTD-related information as UE capability. For example, the UE may be classified into several types based on the MTTD and/or MRTD it can handle for multi-TRP transmissions. By way of example but not limitation, a new UE capability element related to the MTTD may be defined as
MTTDtype-mTRP ENUMERATED {type 1, type 2, type 3},
   where the value of MTTDtype-mTRP indicates the MTTD that can be handled by the UE, including:
type 1: the UE is capable of handling MTTD=CP+M1 in FR1 and/or MTTD=CP+M2 in FR2;
type 2: the UE is capable of handling MTTD=34.6 μs in FR1 and/or MTTD=8.5 μs in FR2; and
type 3: the UE is capable of handling MTTD=half slot (or capable of async).

Similarly, by way of example but not limitation, a new UE capability element related to the MRTD may be defined as
MRTDtype-mTRP ENUMERATED {type 1, type 2, type 3},
   where the value of MRTDtype-mTRP indicates the MRTD that can be handled by the UE, including:
type 1: the UE is capable of handling MRTD=CP in FR1 and/or MRTD=CP in FR2;
type 2: the UE is capable of handling MRTD=33 μs in FR1 and/or MRTD=8 μs in FR2; and
type 3: the UE is capable of handling MRTD=half slot (or capable of async).

The new UE capability could be reported on basis of per UE, per frequency range (FR), per band combination (BC), or per band.

Alternatively, the UE may report a value of the MTTD and/or a value of the MRTD as new UE assistance information (UAI). The value of the MTTD and/or the MRTD may or may not be quantified or graded.

Based on the MTTD/MRTD-related information reported by the UE, whether in a form of UE capability information or UAI, the base station may define and configure the UE with one or more events for triggering a report by the UE. By way of example but not limitation, at least one of the following events may be defined:
Event 1: TTD of multiple TRPs becomes no larger than a threshold; and
Event 2: TTD of multiple TRPs becomes larger than a threshold.

The threshold in Event 1 or Event 2 may be determined by the based station based on the MTTD information as reported by the UE. For example, the threshold may be Y1=limit−D1 (e.g., as shown in FIG. 6), where D1 may take a value of 0, or ¼CP, or ⅓CP, or ½CP, or the like, and the limit may be determined from MTTD.

For TRPs with which the UE has not performed uplink transmissions yet, the TTD may be not available. In this case, the base station may define and configure the UE with one or more events based on RTD. By way of example but not limitation, at least one of the following events may be defined:
Event 1′: RTD of multiple TRPs becomes no larger than a threshold; and
Event 2′: RTD of multiple TRPs becomes larger than a threshold.

The threshold in Event 1′ or Event 2′ may be determined by the based station based on the MRTD information as reported by the UE. For example, the threshold may be Y2=limit-D2 (e.g., as shown in FIG. 6), where D2 may take a value of 0, or ¼CP, or ⅓CP, or ½CP, or the like, and the limit may be determined from MRTD.

In context of the present application, Event 1 and Event 1′ can be collectively referred to as a first event, while Event 2 and Event 2′ can be collectively referred to as a second event. In general, the first event is intended to indicate that the actual TTD falls into a scope of competence of the UE, while the second event is intended to indicate that the actual TTD becomes beyond the scope of competence of the UE. For a scenario of more than two TRPs, the TTD or RTD of these TRPs may be a maximum of TTDs or RTDs of each pair of TRPs.

The configuration of the events can be performed via RRC signaling, for example, in response to the MTTD/MRTD-relation information reported by the UE, or when a TRP fails in reception of uplink transmission from the UE, or even is not necessary.

The base station may configure multiple TRPs in one or more TAGS via RRC signaling, for purpose of TA management. At present, it is cells that are included in a TAG. However, there are cases where several TRPs correspond to a cell and have the same physical cell identity (PCI). To configure the TAG in a granularity of TRP, according to some aspects of the present application, an association between a TAG and it's TRPs may be established.

In one example, an association between a TAG and a set of transmission configuration indicator (TCI) states for use with one or more TRPs. The TCI state is generally used to indicate a quasi co-location (QCL) relationship between two reference signals and thus between two transport channels. The TCI state includes UL TCI state for indicating QCL of UL reference signals, and unified joint TCI state for indicating QCL of DL and UL reference signals. The TCI state indicates a channel between the UE and a corresponding TRP, it may be approximately considered to represent the TRP. By means of the association between the TAG and the TCI state, the TRP is associated with the TAG, and thus with a TA referencing identification (TAG_ID) of the TAG.

In anther example, an association between a TAG and a set of control resource set (CORESET) index values or a set of CORESET pool index values. By means of such association between a TAG and a CORESET index or CORESET pool index dedicated to a TRP, the TRP is associated with the TAG, and thus with a TA for the TAG.

The base station may configure the UE with TAGs under a specific strategy. Examples of TAG management according to some aspects of the present application will be described below with reference to the exemplary scenario of FIG. 3, merely for ease of explanation.

### Example 1 of Multi-TA Operation

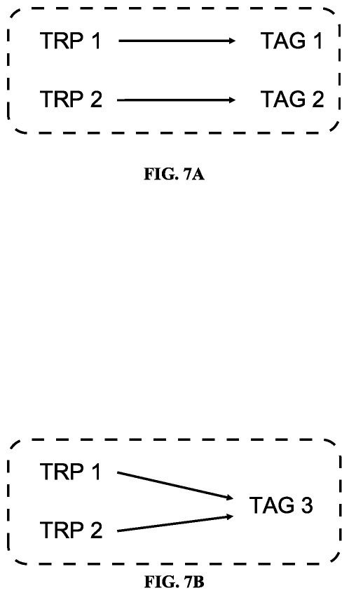

In an example, the UE may be pre-configured with two or more TAGS for multiple TRPs. Referring to FIG. 3, the base station may send to the UE a RRC configuration that configures two TAGs for TRP 1 and TRP 2, that is, TRP 1 is configured in TAG 1 and TRP 2 is configured in TAG 2 as illustrated in FIG. 7A, for example, by any of the associations as described above. It should be noted that the number of TAGs and the number of TRPs in each TAG are not limited thereto.

Optionally, the base station may additionally provide a candidate configuration of single TAG to UE. For example, illustrated in FIG. 7B, the candidate configuration configures one TAG (i.e., TAG 3) for TRP 1 and TRP 2, for example, by associating TAG 3 with both of TRP 1 and TRP 2. TAG 3 may be one of TAG 1 and TAG 2, or even a different TAG from TAG 1 and TAG 2. In particular, the candidate configuration is applied only under a certain condition resolved by the UE or triggered by the base station, for example, in the second event to be described below.

Although the UE have received the configuration of two TAGs (and optionally the candidate configuration of single TAG), appropriateness of the configuration is not verified. According to some aspects of the present application, the UE monitors an actual TTD between TRP 1 and TRP 2. Alternatively, the UE may monitor an actual RTD between TRP 1 and TRP 2 due to some reason, such as because the TTD is not available.

If one or more of the above-mentioned events have been configured by the base station, the UE may decide whether the event or events occur. For example, the UE may determine the first event (Event 1 or Event 1′) when the monitored TTD is not beyond a TTD threshold as configured in the event, or when the monitored RTD is not beyond a RTD threshold as configured in the event, and may determine the second event (Event 2 or Event 2′) when the monitored TTD is beyond a TTD threshold as configured in the event, or when the monitored RTD is beyond a configured RTD threshold as configured in the event.

Alternatively, if the above-mentioned events have not been configured, the UE may perform a similar determination. For example, the UE may compare the actual TTD with a threshold, such as (MTTD-D1), where D1 may be pre-defined in a specification (e.g., a release of 3GPP), taking a value of 0, or ¼CP, or ⅓CP, or ½CP, or the like, alternatively, D1 may be configurable by the base station, for example, D1=ENUMERATED {0, ¼CP, ⅓CP, ½CP . . . }. The UE may alternatively compare the actual RTD with a threshold, such as (MRTD-D2), where D2 may be pre-defined in a specification, taking a value of 0, or ¼CP, or ⅓CP, or ½CP, or the like, or may be configurable by the base station, for example, D2=ENUMERATED {0, ¼CP, ⅓CP, ½CP . . . }. If the actual TTD/RTD is not beyond the respective threshold, the UE may determine there is the first event, otherwise, the UE may determine there is the second event.

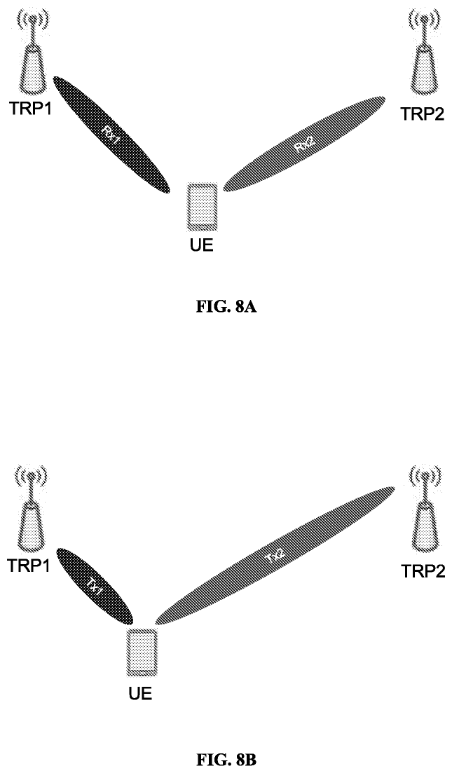

The first event occurs, possibly because a difference between the distance from the UE to TRP 1 and the distance from the UE to TRP 2 is small, as illustrated in FIG. 8A. In case of the first event, the TTD is within the UE's capability to support two TAs for TRP 1 and TRP 2, and the UE may enable the configuration of two TAGs as shown in FIG. 7A. In an example, the UE may inform the base station of the first event by sending a report, for example, using a RRC message, a MAC CE (to one of the serving TRPs) or Layer 1 (L1) reporting based on PUCCH or PUSCH. On the network side, in response to the report, the base station calculates and provides separate TACs for the two TAGs (TAG 1, TAG 2), and on the UE side, the UE applies separate TAs to uplink transmissions to TRP 1 and TRP 2. In another example, the enablement of the two-TAGs configuration may be done without a report, that is, the UE does not send a report for the first event, and the base station provides separate TACs for the two TAGs unless an opposite report is received.

On the other hand, the second event may occur, possibly because a difference between the distance from the UE to TRP 1 and the distance from the UE to TRP 2 is large, as illustrated in FIG. 8B. In case of the second event, the TTD is out of the UE's capability to support two TAs for TRP 1 and TRP 2.

In an example, if a candidate configuration of single TAG is pre-configured as described above, the UE may enable this candidate configuration. The UE may inform the base station of the second event. Once receiving such report, the base station may adapt to the candidate configuration, for example, stop providing separate TACs for the two TAGs (TAG 1, TAG 2), and start providing a TAC for the candidate TAG 3. Based on the TAC for TAG 3, the UE applies the same TA to uplink transmissions to TRP 1 and TRP 2. Thereby, the UE falls back to single TA operation.

In another example, if a candidate configuration of single TAG is not pre-configured as described above, the UE may enable one of TAG 1 and TAG 2 by suspending the other. In other words, the UE may perform uplink transmission to only the enabled TAG, for example, TAG 1 (and thus TRP 1). For example, the UE may enable a specific TAG indicated by the base station, e.g., the base station can indicate a primary TAG (pTAG) which contains a special cell (SpCell) of a MAC entity and a secondary TAG (sTAG) which refers to other TAGs, and based on the indication, the UE may enable the pTAG while suspending the sTAG. However, such explicit indication from the base station may not be needed, and the UE may enable the pTAG according to requirements in a technical specification. Alternatively, the UE may enable any one of the TAGs. The UE may send a report for the second event to the base station, and the base station provides only a TAC for the enabled TAG. The UE may not send a report for the second event, and as a result, receives two TACs for TAG 1 and TAG 2, but applies only the TAC for TAG 1.

In another example, the UE sends a report for the second event to the base station. In response to the report, the base station may provide a reconfiguration that configures the TRPs in a single TAG. When receiving the reconfiguration, the UE may enable the single TAG for TRP 1 and TRP 2, and receive subsequent TAC for the TAG.

In yet another example, in response to the report for the second event, the base station may switch the TCI states used by the UE by configuring and indicating a new set of TCI states for the TRPs. The new set of TCI states can be selected to ensure the TTD is within the UE's capability. The base station configures the UE with an association of the new TCI states with two TAGs for TRP 1 and TRP 2, either the original TAGs or new TAGs. Due to the switch of the TCI states, spatial beams used by the UE for uplink transmissions are changed, resulting in a change of signal propagation paths and a reduction of the TTD.

### Example 2 of Multi-TA Operation

In this example, the UE may be pre-configured with one TAG for multiple TRPs. Referring to FIG. 3, the base station may send to the UE a RRC configuration that configures one TAG for either or both of TRP 1 and TRP 2, for example, by any of the associations as described above.

According to some aspects of the present application, the UE monitors an actual TTD between TRP 1 and TRP 2. Alternatively, if the UE has not performed uplink transmission with either or both of TRP 1 and TRP 2, the TTD is not available, the UE may monitor an actual RTD between TRP 1 and TRP 2.

If one or more of the above-mentioned events have been configured by the base station, the UE may decide whether the event or events occur. For example, the UE may determine the first event (Event 1 or Event 1′) when the monitored TTD is not beyond a TTD threshold as configured in the event, or when the monitored RTD is not beyond a RTD threshold as configured in the event, and may determine the second event (Event 2 or Event 2′) when the monitored TTD is beyond a TTD threshold as configured in the event, or when the monitored RTD is beyond a configured RTD threshold as configured in the event.

Alternatively, if the above-mentioned events have not been configured, the UE may perform a similar determination. For example, the UE may compare the actual TTD with a threshold, such as (MTTD-D1), where D1 may be pre-defined in a specification or may be configurable by the base station. The UE may alternatively compare the actual RTD with a threshold, such as (MRTD-D2), where D2 may be pre-defined in a specification or may be configurable by the base station. If the actual TTD/RTD is not beyond the respective threshold, the UE may determine there is the first event, otherwise, the UE may determine there is the second event.

In case of the second event, the UE receives a TAC for the single TAG as configured, and based on the received TAC, applies the same TA for uplink translations to TRP 1 and TRP 2. Optionally, the UE may send a report for the second event to the base station, for example, via RRC, MAC or L1 reporting, so that the base station continues providing a single TAC for the TAG.

In case of the first event, the UE sends a report for the first event to the base station. In response to the report, the base station can trigger the UE to transmit a random access channel (RACH) such as PRACH to the TRP with which the UE is not performing uplink transmission. For example, provided that the UE does not perform the uplink transmission with TRP 2, and the UE may transmit a PRACH to achieve uplink synchronization with TRP 2. The base station may estimate a TA for TRP 2 based on a preamble carried in the PRACH, and reconfigure TRP 2 in a different TAG from TRP 1. Based on the reconfiguration, the UE may enable separate TAGs for TRP 1 and TRP 2, and thus apply separate TAs for uplink transmissions to these two TRPs.

With a similar procedure, the base station may indicate the UE to transmit a PRACH to a new TRP different from TRP 1 and TRP 2, and reconfigures TRP 1, TRP 2 and the new TRP in two or more TAGs. Details are not described here.

If the UE has performed uplink transmissions with TRP 1 and TRP 2, then in response to the report for the first event, the base station may estimate TA values based on the received uplink signals from them, and reconfigures TRP 1 and TRP 2 in two TAGs. The reconfiguration results in the UE supporting separate TAGs (and thus TAs) for the TRPs.

For ease of explanation, the above examples are described with reference to FIG. 3 with TRP 1 in TAG 1 and TRP 2 in TAG 2, however, it should be noted that the number of TAGs is not limited to two, and the number of TRPs in each TAG is not limited to one. The embodiments of the present application may support management for more than two TAGs under the similar principle.

FIG. 9 is a flowchart diagram illustrating an example method for supporting the multi-TRP operation according to some aspects of the present application. The method may be carried out at a UE.

At 101, the UE monitors a TTD between multiple TRPs, or monitors a RTD between the multiple TRPs in the TTD is not available. For more the two TRPs, the TTD or RTD may be a maximum of TTDs or RTDs of any two TRPs.

At 102, the UE determines a first event that the TTD or RTD is not beyond a respective threshold, or a second event that the TTD or RTD is beyond a respective threshold. The event or the threshold may be predefined or configurable by the base station.

At 103, the UE enables two or more TAGS for the multiple TRPs in the first event. If the UE is pre-configured with one TAG, then in the first event, the UE may send a report for the first event to the base station which may reconfigures two or more TAGS for the multiple TRPs. If the UE is pre-configured with multiple TAGs, then in the second event, the UE may enable a single TAG, or switch to a new set of TCI states such that the first event occurs.

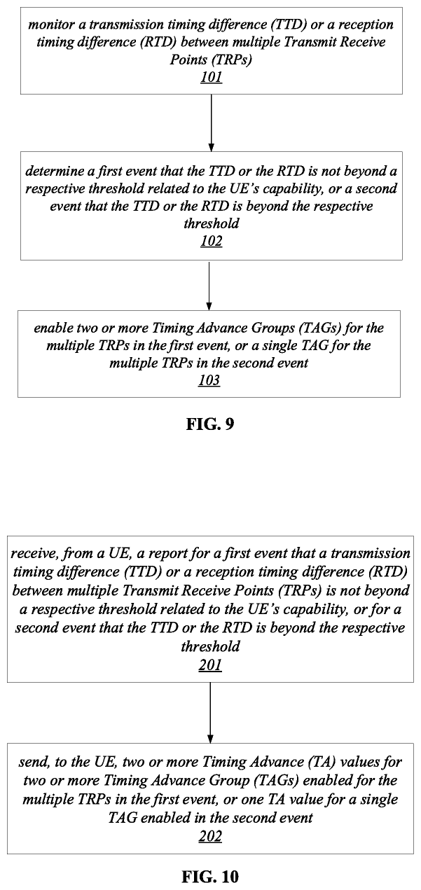

FIG. 10 is a flowchart diagram illustrating an example method for supporting the multi-TRP operation according to some aspects of the present application. The method may be carried out at a base station.

At 201, the base station receives from a UE a report for a first event that a TTD or RTD between multiple TRPs is not beyond a respective threshold related to the UE's capability, or a report for a second event that the TTD or RTD is beyond the respective threshold. The event or the threshold may be predefined or configurable by the base station.

At 202, based on the report for the first event, the base station may know that multiple TAGs for the multiple TRPs can be supported by the UE, and send separate TACs for the multiple TAGs to the UE. Alternatively, based on the report for the first event, the base station may know that only one TAG for the multiple TRPs can be supported by the UE, and send a TAC for the TAG to the UE, or may configure and indicate a new set of TCI states to the UE, such that the first event occurs.

Embodiments contemplated herein include an apparatus comprising means to perform one or more elements of the method as shown in FIG. 9. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 9. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method as shown in FIG. 9. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 9. This apparatus may be, for example, an apparatus of a UE (such as a wireless device 202 that is a UE, as described herein).

Embodiments contemplated herein include a signal as described in or related to one or more elements of the method as shown in FIG. 9.

Embodiments contemplated herein include a computer program or computer program product comprising instructions, wherein execution of the program by a processor is to cause the processor to carry out one or more elements of the method as shown in FIG. 9. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method as shown in FIG. 10. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 10. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method as shown in FIG. 10. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 10. This apparatus may be, for example, an apparatus of a base station (such as a network device 218 that is a base station, as described herein).

Embodiments contemplated herein include a signal as described in or related to one or more elements of the method as shown in FIG. 10.

Embodiments contemplated herein include a computer program or computer program product comprising instructions, wherein execution of the program by a processing element is to cause the processing element to carry out one or more elements of the method as shown in FIG. 10. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

### Example Section

The following examples pertain to further embodiments.
Example 1 may include an apparatus of a user equipment (UE), the apparatus comprising: a processor; and a memory storing instructions that, when executed by the processor, configure the apparatus to: monitor a transmission timing difference (TTD) or a reception timing difference (RTD) between multiple Transmit Receive Points (TRPs); determine a first event that the TTD or the RTD is not beyond a respective threshold related to the UE's capability, or a second event that the TTD or the RTD is beyond the respective threshold; and enable two or more Timing Advance Groups (TAGs) for the multiple TRPs in the first event, or a single TAG for the multiple TRPs in the second event.
Example 2 may include the apparatus of Example 1, wherein the UE is pre-configured with a RRC configuration that configures the multiple TRPs in the two or more TAGs by a base station.
Example 3 may include the apparatus of Example 2, wherein the instructions that, when executed by the processor, further configure the apparatus to: in the first event, receive, from the base station, two or more Timing Advance (TA) values corresponding to the two or more TAGS, respectively.
Example 4 may include the apparatus of Example 3, wherein the instructions that, when executed by the processor, further configure the apparatus to: in the first event, send a report for the first event to the base station, wherein the two or more TA values are sent by the base station in response to the report.
Example 5 may include the apparatus of Example 2, wherein the UE is pre-configured with a candidate RRC configuration that configures the multiple TRPs in a single TAG by the base station, and wherein the instructions that, when executed by the processor, further configure the apparatus to: in the second event, send a report for the second event to the base station; and receive, from a base station, one Timing Advance (TA) value corresponding to the single TAG.
Example 6 may include the apparatus of Example 2, wherein the instructions that, when executed by the processor, further configure the apparatus to: in the second event, send a report for the second event to the base station; receive, from a base station, a RRC reconfiguration that configures the multiple TRPs in a single TAG; and receive, from a base station, one Timing Advance (TA) value corresponding to the single TAG.
Example 7 may include the apparatus of Example 2, the instructions that, when executed by the processor, further configure the apparatus to: in the second event, enable one of the two or more TAGs by suspending remaining TAGs.
Example 8 may include the apparatus of Example 1, wherein the TAG is configured to be associated with at least one of a set of Transmission Configuration Indicator (TCI) states for the TRPs, a set of Control Resource Set (CORESET) index values for the TRPs, or a set of CORESET pool index values for the TRPs.
Example 9 may include the apparatus of Example 8, wherein the instructions that, when executed by the processor, further configure the apparatus to: in the second event, send a report for the second event to the base station; receive from the base station a RRC reconfiguration that associate the two or more TAGs with a different set of TCI states for the multiple TRPs; and use the different set of TCI states for uplink transmissions to the multiple TRPs, so that the TTD or the RTD between the multiple TRPs is not beyond the threshold.
Example 10 may include the apparatus of Example 1, wherein the UE is pre-configured with a RRC configuration that configures the multiple TRPs in one TAG by a base station, and wherein the instructions that, when executed by the processor, further configure the apparatus to: in the first event, send a report for the first event to the base station; receive, from the base station, a RRC reconfiguration that configures the multiple TRPs in two or more TAGS; and receive, from a base station, two or more Timing Advance (TA) values corresponding to the two or more TAGS, respectively.
Example 11 may include the apparatus of Example 10, wherein the instructions that, when executed by the processor, further configure the apparatus to: for at least one TRP of the multiple TRPs with which the UE has not performed uplink transmission, transmit an uplink signal or Random Access Channel (RACH) to the at least one TRP for calculation of Timing Advance (TA) value;
Example 12 may include the apparatus of Example 1, wherein the respective threshold for the TTD or RTD is predefined in a specification or configurable by a base station.
Example 13 may include the apparatus of Example 1, wherein the instructions that, when executed by the processor, further configure the apparatus to: send, to a base station, information on maximum TTD (MTTD) or maximum RTD (MRTD) that can be supported by the UE, the information including a type of the UE classified based on the MTTD or MRTD, or a value of the MTTD or MRTD; and receive, from the base station, a RRC configuration regarding the first event and the second event which are based on the information on the MTTD or MRTD.
Example 14 may include an apparatus of a base station, the apparatus comprising: a processor; and a memory storing instructions that, when executed by the processor, configure the apparatus to: receive, from a UE, a report for a first event that a transmission timing difference (TTD) or a reception timing difference (RTD) between multiple Transmit Receive Points (TRPs) is not beyond a respective threshold related to the UE's capability, or for a second event that the TTD or the RTD is beyond the respective threshold; and send, to the UE, two or more Timing Advance (TA) values for two or more Timing Advance Group (TAGs) enabled for the multiple TRPs in the first event, or one TA value for a single TAG enabled in the second event.
Example 15 may include the apparatus of Example 14, wherein the instructions that, when executed by the processor, configure the apparatus to: pre-configure the UE with a RRC configuration that configures the multiple TRPs in the two or more TAGS.
Example 16 may include the apparatus of Example 15, wherein the instructions that, when executed by the processor, configure the apparatus to: pre-configure the UE with a candidate RRC configuration that configures the multiple TRPs in a single TAG, and in response to the report for the second event, send, to the UE, one TA value corresponding to the single TAG.
Example 17 may include the apparatus of Example 15, wherein the instructions that, when executed by the processor, further configure the apparatus to: in response to the report for the second event, send, to the UE, a RRC reconfiguration that configures the multiple TRPs in a single TAG; and send, to the UE, one Timing Advance (TA) value corresponding to the single TAG.
Example 18 may include the apparatus of Example 15, wherein the TAG is configured to be associated with at least one of a set of Transmission Configuration Indicator (TCI) states for the TRPs, a set of Control Resource Set (CORESET) index values for the TRPs, or a set of CORESET pool index values for the TRPs.
Example 19 may include the apparatus of Example 18, wherein the instructions that, when executed by the processor, further configure the apparatus to: in response to the report for the second event, send, to the UE, a RRC reconfiguration that associate the two or more TAGS with a different set of TCI states for the multiple TRPs, which causes the TTD or the RTD between the multiple TRPs to be not beyond the threshold.
Example 20 may include the apparatus of Example 14, wherein the instructions that, when executed by the processor, further configure the apparatus to: pre-configure the UE with a RRC configuration that configures the multiple TRPs in one TAG by a base station; in response to the report for the first event, send, to the UE, a RRC reconfiguration that configures the multiple TRPs in two or more TAGS; and send, to the UE, two or more Timing Advance (TA) values corresponding to the two or more TAGS, respectively.
Example 21 may include the apparatus of Example 20, wherein the instructions that, when executed by the processor, further configure the apparatus to: indicate the UE to transmit an uplink signal or Random Access Channel (RACH) to at least one TRP of the multiple TRPs with which the UE has not performed uplink transmission, for calculation of Timing Advance (TA) value.
Example 22 may include the apparatus of Example 14, wherein the instructions that, when executed by the processor, further configure the apparatus to: receive, from the UE, information on maximum TTD (MTTD) or maximum RTD (MRTD) that can be supported by the UE, the information including a type of the UE classified based on the MTTD or MRTD, or a value of the MTTD or MRTD, configure the UE with the first event and the second event based on the information on the MTTD or MRTD.
Example 23 may include a method, comprising: monitoring a transmission timing difference (TTD) or a reception timing difference (RTD) between multiple Transmit Receive Points (TRPs); determining a first event that the TTD or the RTD is not beyond a respective threshold related to the UE's capability, or a second event that the TTD or the RTD is beyond the respective threshold; and enabling two or more Timing Advance Groups (TAGs) for the multiple TRPs in the first event, or a single TAG for the multiple TRPs in the second event.
Example 24 may include a method, comprising: receiving, from a UE, a report for a first event that a transmission timing difference (TTD) or a reception timing difference (RTD) between multiple Transmit Receive Points (TRPs) is not beyond a respective threshold related to the UE's capability, or for a second event that the TTD or the RTD is beyond the respective threshold; and sending, to the UE, two or more Timing Advance (TA) values for two or more Timing Advance Group (TAGs) enabled for the multiple TRPs in the first event, or one TA value for a single TAG enabled in the second event.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE), the apparatus comprising:
a processor; and
a memory storing instructions that, when executed by the processor, configure the apparatus to:
monitor a transmission timing difference (TTD) or a reception timing difference (RTD) between multiple Transmit Receive Points (TRPs);
determine a first event that the TTD or the RTD is not beyond a respective threshold related to a UE capability, or a second event that the TTD or the RTD is beyond the respective threshold; and
enable two or more Timing Advance Groups (TAGs) for the multiple TRPs in the first event, or a single TAG for the multiple TRPs in the second event.

2. The apparatus of claim 1, wherein the UE is pre-configured with a RRC configuration that configures the multiple TRPs in the two or more TAGs by a base station.

3. The apparatus of claim 2, wherein the instructions that, when executed by the processor, further configure the apparatus to:
in the first event, receive, from the base station, two or more Timing Advance (TA) values corresponding to the two or more TAGS, respectively.

4. The apparatus of claim 3, wherein the instructions that, when executed by the processor, further configure the apparatus to:
in the first event, send a report for the first event to the base station,
wherein the two or more TA values are sent by the base station in response to the report.

5. The apparatus of claim 2, wherein the UE is pre-configured with a candidate RRC configuration that configures the multiple TRPs in the single TAG by the base station, and
wherein the instructions that, when executed by the processor, further configure the apparatus to:
in the second event, send a report for the second event to the base station; and
receive, from the base station, one Timing Advance (TA) value corresponding to the single TAG.

6. The apparatus of claim 2, wherein the instructions that, when executed by the processor, further configure the apparatus to:
in the second event, send a report for the second event to the base station;
receive, from the base station, a RRC reconfiguration that configures the multiple TRPs in the single TAG; and
receive, from the base station, one Timing Advance (TA) value corresponding to the single TAG.

7. The apparatus of claim 2, the instructions that, when executed by the processor, further configure the apparatus to:
in the second event, enable one of the two or more TAGs by suspending remaining TAGs.

8. The apparatus of claim 1, wherein the single TAG is configured to be associated with at least one of:
a set of Transmission Configuration Indicator (TCI) states for the TRPs,
a set of Control Resource Set (CORESET) index values for the TRPs, or
a set of CORESET pool index values for the TRPs.

9. The apparatus of claim 8, wherein the instructions that, when executed by the processor, further configure the apparatus to:
in the second event, send a report for the second event to a base station;
receive from the base station a RRC reconfiguration that associate the two or more TAGs with a different set of TCI states for the multiple TRPs; and
use the different set of TCI states for uplink transmissions to the multiple TRPs, so that the TTD or the RTD between the multiple TRPs is not beyond the threshold.

10. The apparatus of claim 1, wherein the UE is pre-configured with a RRC configuration that configures the multiple TRPs in one TAG by a base station, and
wherein the instructions that, when executed by the processor, further configure the apparatus to:
in the first event, send a report for the first event to the base station;
receive, from the base station, a RRC reconfiguration that configures the multiple TRPs in the two or more TAGS; and
receive, from the base station, two or more Timing Advance (TA) values corresponding to the two or more TAGS, respectively.

11. The apparatus of claim 10, wherein the instructions that, when executed by the processor, further configure the apparatus to:
for at least one TRP of the multiple TRPs with which the UE has not performed uplink transmission, transmit an uplink signal or Random Access Channel (RACH) to the at least one TRP for calculation of Timing Advance (TA) value.

12. The apparatus of claim 1, wherein the respective threshold for the TTD or RTD is predefined in a specification or configurable by a base station.

13. The apparatus of claim 1, wherein the instructions that, when executed by the processor, further configure the apparatus to:
send, to a base station, information on maximum TTD (MTTD) or maximum RTD (MRTD) that can be supported by the UE, the information including a type of the UE classified based on the MTTD or MRTD, or a value of the MTTD or MRTD; and
receive, from the base station, a RRC configuration regarding the first event and the second event which are based on the information on the MTTD or MRTD.

14. An apparatus of a base station, the apparatus comprising:
a processor; and
a memory storing instructions that, when executed by the processor, configure the apparatus to:
receive, from a UE, a report for a first event that a transmission timing difference (TTD) or a reception timing difference (RTD) between multiple Transmit Receive Points (TRPs) is not beyond a respective threshold related to a UE capability, or for a second event that the TTD or the RTD is beyond the respective threshold; and
send, to the UE, two or more Timing Advance (TA) values for two or more Timing Advance Group (TAGs) enabled for the multiple TRPs in the first event, or one TA value for a single TAG enabled in the second event.

15. The apparatus of claim 14, wherein the instructions that, when executed by the processor, configure the apparatus to:
pre-configure the UE with a RRC configuration that configures the multiple TRPs in the two or more TAGs.

16. The apparatus of claim 15, wherein the instructions that, when executed by the processor, configure the apparatus to:
pre-configure the UE with a candidate RRC configuration that configures the multiple TRPs in the single TAG, and
in response to the report for the second event, send, to the UE, one TA value corresponding to the single TAG.

17. The apparatus of claim 15, wherein the instructions that, when executed by the processor, further configure the apparatus to:
in response to the report for the second event, send, to the UE, a RRC reconfiguration that configures the multiple TRPs in the single TAG; and
send, to the UE, one Timing Advance (TA) value corresponding to the single TAG.

18. The apparatus of claim 15, wherein the single TAG is configured to be associated with at least one of:
a set of Transmission Configuration Indicator (TCI) states for the TRPs,
a set of Control Resource Set (CORESET) index values for the TRPs, or
a set of CORESET pool index values for the TRPs.

19. The apparatus of claim 18, wherein the instructions that, when executed by the processor, further configure the apparatus to:
in response to the report for the second event, send, to the UE, a RRC reconfiguration that associate the two or more TAGs with a different set of TCI states for the multiple TRPs, which causes the TTD or the RTD between the multiple TRPs to be not beyond the threshold.

20. The apparatus of claim 14, wherein the instructions that, when executed by the processor, further configure the apparatus to:
pre-configure the UE with a RRC configuration that configures the multiple TRPs in one TAG by the base station;
in response to the report for the first event, send, to the UE, a RRC reconfiguration that configures the multiple TRPs in the two or more TAGS; and
send, to the UE, two or more Timing Advance (TA) values corresponding to the two or more TAGS, respectively.

21-24. (canceled)
